(19) United States
(12) Patent Application Publication
(10) Pub. No.: US 2011/0206314 A1
(43) Pub. Date: Aug. 25, 2011

(54) Method for Generating a Spectral Broadband Source by Phase Matching Including Leaky Modes

(75) Inventors: Vincent Couderc, Verneuil-Sur-Vienne (FR); Paul-Henri Pioger, Limoges (FR); Alain Barthelemy, Limoges (FR); Philippe Paul Leproux, Saint Pardoux (FR); Dominique Pagnoux, Limoges (FR); Guillaume Huss, Limoges (FR)

(73) Assignee: Centre National De La Recherche Scientifique -CNRS, Paris (FR)

(21) Appl. No.: 12/224,585

(22) PCT Filed: Mar. 1, 2007
(86) PCT No.: PCT/FR2007/050859

§ 371 Date: Apr. 7, 2011

(30) Foreign Application Priority Data
Mar. 1, 2006 (FR) 0601839

(51) Int. Cl. G02B 6/00; G02B 6/26

(52) U.S. Cl. 385/11; 385/15

(57) ABSTRACT

The disclosure relates to an optical waveguide serving to propagate an original light signal, the optical waveguide including a non-linear waveguide first core that is suitable for generating leaky modes from the original light signal, the waveguide including at least a second core, the first core being included in the second core, the second core being arranged relative to the first core in such a manner as to confine at least the leaky modes generated by the first core from the original light signal outside the first core. By the above-described waveguide, in particular by the non-linearities of the first core of the waveguide, a light continuum can be generated inside the fiber by collinear phase matching. In addition, by Cerenkov effect, other wavelengths are generated by the wavelengths of the continuum by non-collinear phase matching.

### CROSS-REFERENCE TO RELATED APPLICATIONS

This application is a National Phase Entry of International Application No. PCT/FR2007/050859, filed on Mar. 1, 2007, which claims priority to French Application FR 06/01839, filed on Mar. 1, 2006, both of which are incorporated by reference herein.

### BACKGROUND AND SUMMARY

The present invention relates to the field of methods of generating light sources, and in particular broadband or continuum light sources.

Methods of generating a continuum of light are known from the prior art, e.g. from KOHERAS's Documents WO 2005/062113 or WO 2005/071483. In a manner known per se, methods of generating a continuum of light use an optical waveguide such as an optical fiber having electromagnetic field confinement and dispersion properties, e.g. a non-linear fiber. Light radiation having a narrow spectrum is injected into the inlet of the fiber, and that spectrum is spread by the non-linear properties of the waveguide coupled with dispersion properties. A first object of the present invention is to provide an alternative to known methods of generating a light continuum.

Conventionally, a continuum is generated in optical fibers by means of various non-linear effects such as the Raman effect, parametric effects, or phase self-modulation. Parametric effects make it possible to obtain smooth spectra over broad spectral widths, and are currently the non-linear effects that are most promising for generating broad spectra. However, those effects require phase speed matching between the pump waves and the signal waves. Such phase matching depends on the dispersion curve of the optical waveguide, on the direction of propagation of the guided modes, and on the powers conveyed on each of them. In single-mode propagation, a single propagation direction is given preference, and the spectral range over which phase matching remains possible is limited, which results in less spectral broadening. Another object of the present invention is thus to facilitate phase matching in waveguides designed to generate light continua.

In the field of waveguides, the Cerenkov effect is known that uses “leaky mode” propagation modes in which light escapes from the waveguide. That effect is described, for example, for certain waveguides in the articles by Kiyofumi Chikuma et al. (“Theory of optical second-harmonic generation in crystal-core fibers based on phase matching of Cerenkov-type radiation”, Opt. Soc. Am. B, Vol. 9, No. 7, Jul. 1992) and by K. Hayata et al. (“Enhancement of the guided-wave second harmonic generation in the form of Cerenkov radiation”, Appl. Phys. Lett., 56 (3) 15 Jan. 1990). With the Cerenkov effect, a fraction of the light wave propagating in the core of the fiber can be converted into another wavelength that propagates non-collinearly. That propagation (leaky mode) in a direction other than in the direction of the guided mode makes it possible to obtain phase matching between the waves and thus to convert a fraction of the radiation to other frequencies. Such non-conventional conversion is possible only when there exists non-zero overlap between the core mode and the leaky mode.

When a light wave travels through an optical fiber, a fraction of the energy propagating in the core can be radiated to the outside via coupling with non-guided modes. Those modes are then referred to as “leaky modes” and are a fundamental characteristic of the Cerenkov effect. The Cerenkov effect is thus an example of propagation with non-collinear phase matching. This effect is, for example, observable with the naked eye, and corresponds to the waveguide being illuminated not only at the outlet of the fiber, but also over the entire length of the fiber, as shown in FIG. 1. In FIG. 1, and in a manner known per se, an inlet wave 1 penetrates into the fiber 2. By means of the Cerenkov effect, and depending on the characteristics of the fiber 2, a fraction of the wave 1 is guided in the fiber in the form of a wavelength 3 of wavelength vector k collinear with the wavelength vector of the inlet wave 1, and a fraction of the wave exits from the fiber in the form of a leaky wave 4 of wavelength vector k′ extending in a direction different from the direction of the vector k.

A first visible effect of those leaky modes can be observed because the leaky wave exits from the fiber and thus illuminates said fiber over its entire length. A second visible effect is that, at the outlet of the fiber, the wave is distributed in a ring configuration rather than as a central spot whose propagation direction is collinear with the axis of the fiber as in the absence of leaky modes. The ring is also shown in FIG. 1. These leaky mode effects are usually undesired effects in linear fibers because a fraction of the power of the input wave 1 is lost in the form of the leaky wave 4. These leaky effects have not been used advantageously for non-linear fibers for generating light continua.

The document referenced XP-002398712, Optics Letters, Vol. 30, No. 12, of Jun. 15, 2005, entitled “Generation of broadband femtosecond visible pulses in dispersion-micromanaged holey fibers”, by Fei Lu et al. addresses generating a light continuum in a waveguide in changeable manner. Generation of the continuum depends on “Cerenkov” radiation from a soliton propagation. However, that type of Cerenkov radiation is a spectral effect and not a spatial effect as it is for the above-described leaky modes. The difference between these two effects is known to the person skilled in the art, as evidenced by the article by Skryabin, Science 301 1705, 2003 referenced in the above-mentioned publication XP-002398712. That document does not describe the use of leaky modes and makes no mention of fibers having more than one core.

In addition, the document by Fedotov et al. entitled “Assorted non-linear optics in microchannel waveguides of photonic-crystal fibers”, Optics Communications 255, 2005, addresses frequency generation in micro-waveguides present in a microstructured fiber. As in the preceding document, the dispersive Cerenkov effect of the document by Fedotov et al. is a spectral effect and not a spatial effect. As above, the document by Skryabin, Science 301 1705, 2003, referenced in the document by Fedotov et al. describes that difference. That document does not describe the use of leaky modes and makes no mention of fibers having more than one core. In the same way, the document referenced XP 002398713, entitled “Generation of a broadband continuum with high spectral coherence in tapered single-mode optical fibers”, Fei Lu et al., Optics Express, Vol. 12, No. 2 concerns a Cerenkov effect of spectral type.

One of the objects of the present invention is to make advantageous use of leaky modes in an optical fiber for the purpose of generating a light continuum. Another object of the present invention is to find an alternative to known continuum generation methods. Furthermore, when parametric effects are implemented with collinear phase matching in single-mode propagation, the spectral range over which phase matching is possible is limited. The spectral broadening obtained is thus also limited. Another object of the present invention is thus to obtain improved spectral broadening in generating broadband sources.

U.S. Pat. No. 4,981,337 teaches generating frequency by spatial Cerenkov effect, and thus by leaky mode. In that document, the frequency generation concerns only second harmonic generation. It is a second-order non-linear effect that does not make it possible to induce broadband conversion. In addition, no polarization effect is described in that document. Finally, that document concerns only a waveguide having a single core. It describes optical cladding surrounding a core, by that cladding has a refractive index equal to the refractive index of the core, so that the assembly comprising the core and the cladding cannot be considered by a person skilled in the art as being a two-core assembly. Thus, the cladding surrounding the core cannot be suitable for guiding the leaky modes generated in the core, so that the spectral power of those modes is lost.

Another object of the invention is to provide a waveguide making it possible to generate a light continuum that has good spectral power. At least one of these objects is achieved with the present invention by an optical waveguide serving to propagate an original light signal, said optical waveguide including a non-linear waveguide first core that is suitable for generating leaky modes from said original light signal, said waveguide including at least a second core, the first core being included in the second core, the second core being arranged relative to the first core in such a manner as to confine at least the leaky modes generated by the first core from said original light signal outside said first core. The waveguide as described above can be used for generating a light continuum or more generally for generating a signal including a plurality of wavelengths from a substantially monochromatic original signal.

By means of the waveguide as described above, in particular by means of the non-linearities of the first core of the waveguide, a light continuum can be generated inside the fiber of the invention by collinear phase matching. In addition, by Cerenkov effect, other wavelengths are generated by means of the wavelengths of the continuum or by means of the original wavelength by using non-collinear phase matching of the Cerenkov type. With such a waveguide of the invention, rather than seeking to eliminate the leaky modes in a waveguide, the aim is to exacerbate and to confine those modes in a concentric second core. This is achieved in particular by providing a second core arranged to confine the leaky modes that exit from the first core, so as to improve the spectral power of the continuum. This results in a new continuum at the outlet of the waveguide in the ring configuration that is characteristic of leaky modes.

More specifically, in a particular embodiment, said original light signal may include at least one original wavelength, said non-linear waveguide first core may be suitable for generating a signal including at least one wavelength from said original light signal, and said first core may further be suitable for generating leaky modes of said signal. In this way, the core of the waveguide is specially adapted to generate signals that are generated by the non-linearities of the waveguide. The invention also provides a device for generating an output light signal, said device comprising at least one pump device suitable for emitting at least one original light signal, a waveguide, and injection means for injecting said original light signal into said waveguide, said device being characterized in that said waveguide is a waveguide as described above. In an embodiment, in order to be able to modify the spectral characteristics of the signal or of the continuum obtained at the outlet of said waveguide, the device further comprises polarization means suitable for modifying the polarization of said original light signal before it is injected into said waveguide.

It is known per se that the refractive index of the waveguide seen by the wave propagating in said waveguide depends on the polarization of the wave. Since the continuum obtained at the outlet of the waveguide depends on the refractive index, on the birefringence and on the dispersion of said waveguide, modifying the polarization of the incident wave therefore modifies the generated spectrum. Alternatively, the polarization means may be suitable for modifying the polarization of said light signal while it is propagating along said waveguide.

In an embodiment, in order to facilitate detection of the signal or of the continuum at the outlet of the waveguide, said device further comprises means for focusing said output light signal generated at the outlet of said waveguide. As explained above, the signal generated using the leaky modes exits from the guide in the form of a ring, which can thus, under certain conditions, pose problems in detecting and in using the generated signals. The focusing means then make it possible to confine the ring into a more homogeneous focal spot. In order to increase the peak power of the wave injected into the fiber, the device of the invention preferably further comprises a power amplifier.

The invention also provides a method of generating an output light signal using an original light signal including at least one original wavelength, and using a non-linear waveguide including at least a non-linear first core, said method comprising a step consisting in:

injecting said original light signal into said non-linear waveguide first core; and in

generating a broadband signal by non-linear effect, which signal includes at least one wavelength, from said original light signal;

said method being characterized in that it further comprises steps consisting in:

generating at least one leaky mode of the signal propagating in the first core and including at least one wavelength so as to obtain a leaky signal propagating outside said non-linear first core; and in

collecting said leaky signal by means of a second core of said waveguide.

In addition, in order to improve the spectral power at the outlet of the waveguide, the method may further comprise a step consisting in guiding said leaky mode by means of a concentric second core in said waveguide. Furthermore, in order to modify the spectral characteristics obtained at the outlet of the fiber, said method further comprises an element of polarization that makes it possible to modify the direction of the polarization vector of said input signal and thus to select the output wavelengths. The invention also provides the use of a waveguide as described above for generating a plurality of wavelengths coming from the leaky modes of a broadband signal generated in said waveguide.

### BRIEF DESCRIPTION OF THE DRAWINGS

The invention can be better understood from the following detailed description and from the accompanying figures in which:

FIG. 1 shows the Cerenkov effect in an optical fiber;

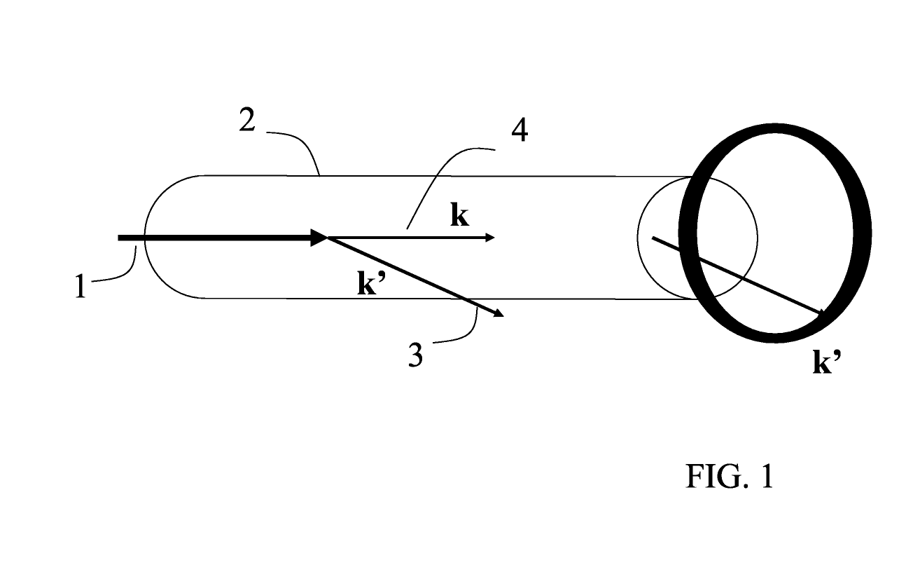

FIG. 2 shows an example of a light generation device of the invention;

FIG. 3 shows an example of a non-linear fiber in an embodiment of the present invention; and

FIGS. 4A and 4B show a comparison of the spectra obtained without the leaky modes (FIG. 4A) and with the leaky modes being used in accordance with the present invention (FIG. 4B).

### DETAILED DESCRIPTION

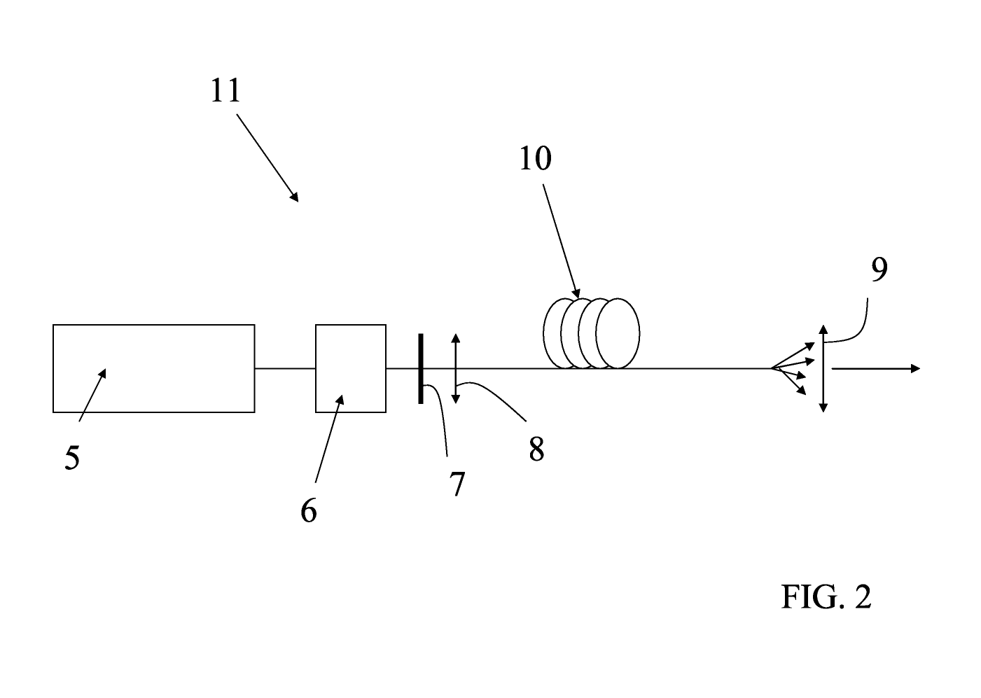

As shown in FIG. 2, a light generation device 11 of the invention comprises a pump device 5 suitable for emitting at least one original signal at a fixed wavelength, and a waveguide 10. These elements are described in more detail below. The device 11 further comprises a power amplifier 6. The purpose of this amplifier is to amplify the original light signal at the wavelength emitted by the pump device 5 so as to increase the power spectral density of the signal generated at the outlet of the waveguide.

The device 11 further comprises a phase plate 7. The purpose of this plate is to make it possible to modify the polarization of the signal emitted by the pump device 5, possibly as amplified by the amplifier 7. The device 11 further comprises a collimation lens 8 whose purpose is to perform the injection into the fiber 10.

For example, the pump device 5 is a compact laser delivering a light signal at 1064 nanometers (nm) that is polarized or otherwise. This laser can be a fiber laser or a solid state laser. It can operate under femtosecond, picosecond, or nanosecond pulse conditions, at variable repetition frequencies. The power amplifier 6 is of a type known per se and makes it possible to increase the peak power of the pulses in order to facilitate non-linear effects in the waveguide 10. This amplifier can however be omitted if the laser 5 is powerful enough.

The polarized and collimated light is injected into the waveguide 10. For example, the waveguide is an optical fiber. For example, the fiber is a microstructured silica fiber that is non-linear in the sense that its silica core makes it possible, by non-linear effect, to generate other frequencies from the injected signal. These non-linear mechanisms are known per se. They make it possible to generate a signal having a plurality of wavelengths from an almost monochromatic original signal. The generated signal can, in particular, take the form of a light continuum. The core of the fiber 10 is also adapted, as a function of the incident wavelength of the original light signal, to make it possible to generate leaky modes by Cerenkov effect outside the core of the fiber. Thus, by means of the non-linearity of the core of the fiber 10, wavelengths are generated by collinear phase matching from the incident wave.

These wavelengths and the wavelength of the incident wave then generate new wavelengths as thy leak from the central core. Their propagation in a direction that is non-collinear with the propagation of energy guided in the core makes it possible to obtain non-collinear phase matching of the Cerenkov type. At the outlet of the fiber 10, a light ring is generated in the leakage direction of the leaky modes in the fiber 10. Thus, in accordance with the invention, this light ring comprises a spectrum made up of a plurality of wavelengths. This spectrum can be broad in frequency and is due to a combination of non-linear effects present while energy is propagating in these leaky modes.

Thus, it is possible to generate a first light continuum in the central core of the fiber by non-linear effect. The first continuum leaks and causes new wavelengths to be generated by Cerenkov effect, thereby generating a second light continuum at the outlet of the fiber. In order to facilitate detection of the output signal from the fiber 10, it is possible to use a device for refocusing the ring-shaped signal. For example, such a re-focusing device is described in detail in the article by Chikuma et al., Applied Optics, Vol. 33, p. 3198, 1994.

As described above, the fiber 10 thus includes a first fiber core. The light coming from the first core, and propagating via the leaky modes, exits from said first core. This leaky effect can, in particular, be observed by viewing the outgoing light energy on the cross section all the way along the fiber.

However, it is advantageous to be able to increase the power spectral density of the light signal at the outlet of the fiber or of the light continuum obtained by recovering that lost light. For this purpose, in a variant of the invention, the fiber 10 of the invention includes a second fiber core, e.g. surrounding the first fiber core, and serving to confine the leaky modes in the fiber at said second core. By adding said second core, the leaky modes are no longer observable with the naked eye along the fiber.

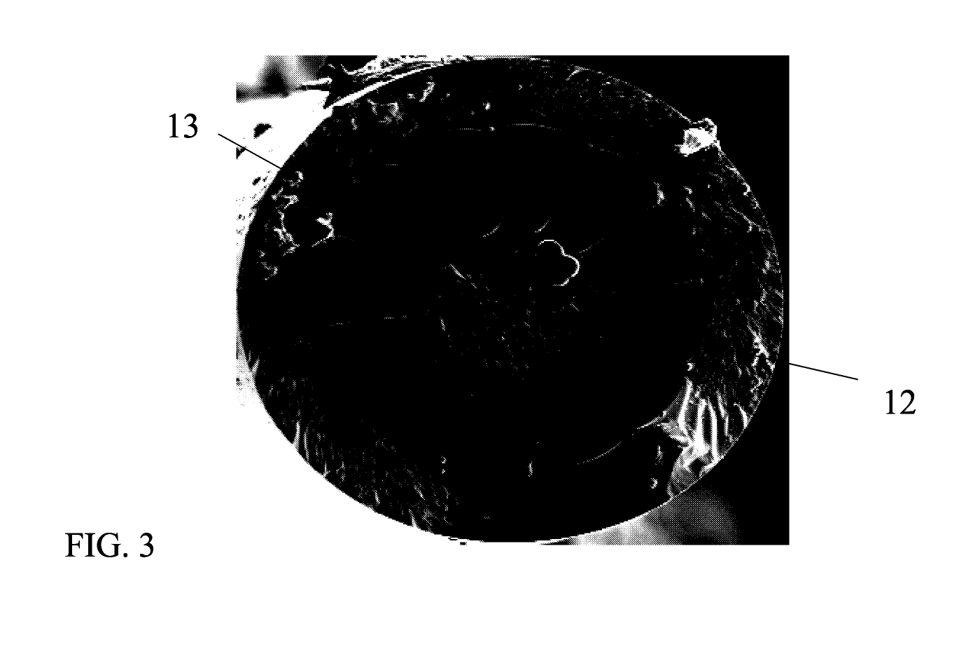

FIG. 3 shows an example of such a two-core fiber 10, the second core 13 making it possible to confine the leaky modes coming from the first core 12. In this figure, the diameter of the first core 12 is 4 μm, the diameter of the holes of the microstructure is 1.8 μm, and the diameter of the second core 13 is 50 μm, for a total outside diameter of 150 μm.

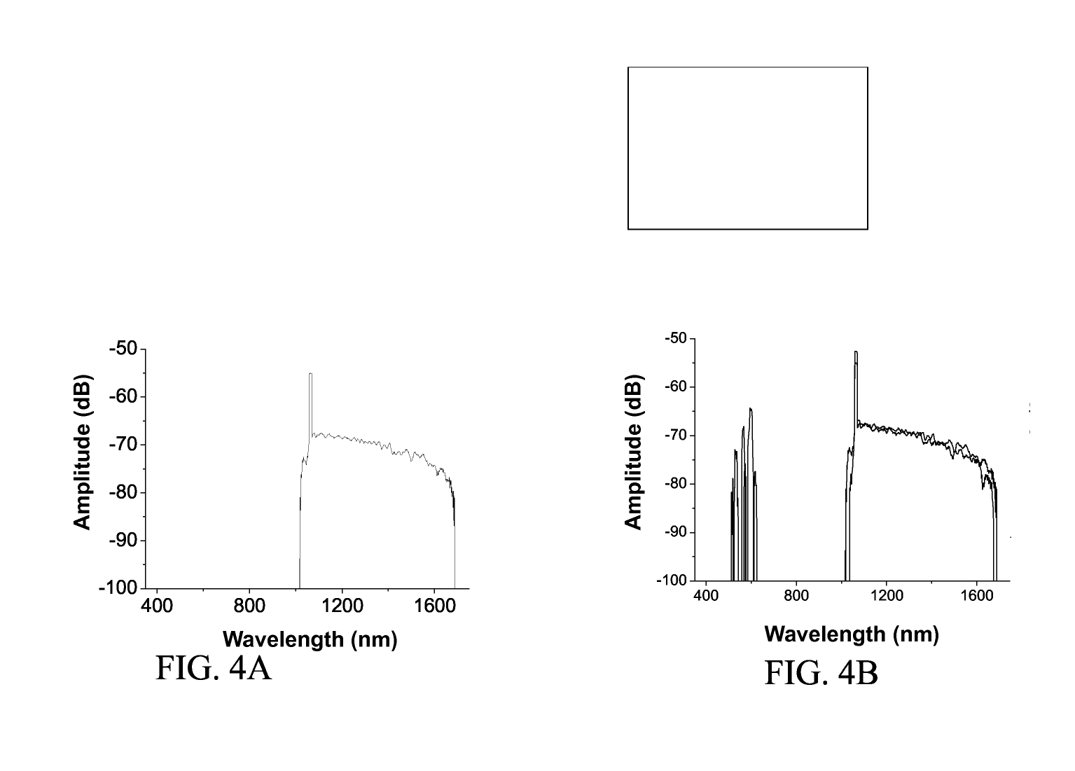

FIGS. 4A and 4B show a comparison of the spectra obtained without the leaky modes (FIG. 4A) and with the leaky modes being used in accordance with the present invention (FIG. 4B). FIG. 4A shows the results obtained for mere spectrum broadening. It can be observed that the broadband spectrum is continuous and extends only in the infrared domain.

By using leaky modes and the device 11 in accordance with the invention, the broadband spectrum obtained also extends in the visible domain. The spectrum generated in this way is no longer fully continuous but rather it shows a multitude of discrete lines. These discrete lines are the signature of point phase matches for a plurality of wavelengths propagating on leaky modes and in a complex structure that can have photonic forbidden bands.

By collecting all of these discrete wavelengths, it is possible to reconstruct an almost continuous spectrum in which all of the wavelengths of the visible radiation are present. In accordance with the invention, it is also possible to modify the distribution of wavelengths in the spectrum corresponding to the leaky modes. It is known that the spectrum of the wave generated by non-linear effect is, in birefringence fibers, a function of the direction of the polarization vector. This direction of the polarization vector makes it possible to obtain or not to obtain phase matching that then makes it possible to initiate the non-linear process. This process, dependent on the polarization, is also present during frequency conversion with leaky modes. A modification in the polarization of the input wave then makes it possible to select output wavelengths.

For a fiber that is, for example, a birefringence fiber, the phase plate 7, e.g. in the form of a half-wave plate, is thus positioned at the inlet of the fiber, making it possible to turn the polarization of the incident wave in the fiber and thus to select the wavelengths emitted on the leaky modes. If the wavelength(s) of the output signal of the fiber is/are fixed, it is then possible to choose the polarization and/or the wavelength of the adapted original signal. For example, it is possible to select the dominant non-linear process during wavelength conversion by changing the direction of the polarization vector. The change of process then makes it possible to change generated wavelength. It is possible, from a wave at 1064 nm, to go from a frequency tripling effect (355 nm) to a frequency doubling effect (532 nm) or to a frequency sum effect from an infrared broad spectrum resulting in generation at 670 nm. It is also to be understood that any method making it possible to improve generation of the continuous spectrum at the outlet of the fiber by the non-linearities can also be used in combination with the present invention, and in particular frequency doubling, frequency tripling, modulational instabilities and/or the Raman effect.

1. An optical waveguide serving to propagate an original light signal, said optical waveguide comprising a non-linear waveguide first core that is suitable for generating leaky modes from said original light signal, and at least a second core, the first core being included in the second core, the second core being arranged relative to the first core in such a manner as to confine at least the leaky modes generated by the first core from said original light signal outside said first core.

2. An optical waveguide according to claim 1, wherein said original light signal includes at least one original wavelength, said non-linear waveguide first core is suitable for generating a signal including at least one wavelength from said original light signal, and said first core is further suitable for generating leaky modes of said signal.

3. A device for generating an output light signal, said device comprising at least one pump device suitable for emitting at least one original light signal, an optical waveguide, and an injector operably injecting said original light signal into said waveguide, said optical waveguide comprising a non-linear waveguide first core that is suitable for generating leaky modes from said original light signal, and at least a second core, the second core being arranged relative to the first core in such a manner as to confine at least the leaky modes generated by the first core from said original light signal outside said first core.

4. A device for generating an output light signal according to claim 3, further comprising a polarizer operably modifying polarization of said original light signal before it is injected into said waveguide.

5. A device for generating an output light signal according to claim 3, further comprising a polarizer operably modifying polarization of said light signal while it is propagating along said waveguide.

6. A device for generating an output light signal according to claim 3, further comprising a power amplifier operably amplifying said original light signal before it is injected into said waveguide.

7. A method of generating an output light signal using an original light signal including at least one original wavelength, and using a non-linear waveguide including at least a non-linear first core, said method comprising:
injecting said original light signal into said non-linear waveguide first core;
generating a broadband signal by non-linear effect, which signal includes at least one wavelength, from said original light signal;
generating at least one leaky mode of the signal propagating in the first core and including at least one wavelength so as to obtain a leaky signal propagating outside said non-linear first core; and
collecting said leaky signal by a second core of said waveguide.

8. A method of generating an output light signal according to claim 7, further comprising confining at least one leaky mode in said second core of said waveguide.

9. A method of generating an output light signal according to claim 7, wherein said output light signal includes at least one outlet wavelength, and said original light signal has a polarization, said method further comprising adapting said polarization of said original light signal as a function of said output wavelength.

10. The use of a device according to claim 3, for generating a plurality of wavelengths coming from the leaky modes of a broadband signal generated in said waveguide.
